(19) United States
(12) Patent Application Publication
(10) Pub. No.: US 2026/0112079 A1
(43) Pub. Date: Apr. 23, 2026

(54) TRAINING AND UTILIZING MACHINE LEARNING MODELS TO EXTRACT VECTOR STROKES FROM RASTER DIGITAL IMAGES

(71) Applicant: Adobe Inc., San Jose, CA (US)

(72) Inventors: Ankit Phogat, Noida (IN); Homi Raghuvanshi, Bhilai (IN); Souymodip Chakraborty, Bangalore (IN); Vineet Batra, Pitam Pura (IN)

(21) Appl. No.: 18/921,823

(22) Filed: Oct. 21, 2024

(51) Int. Cl. G06T 11/20; G06T 3/40; G06T 7/12; G06T 11/60

(52) U.S. Cl. CPC G06T 11/23; G06T 3/40; G06T 7/12; G06T 11/60

(57) ABSTRACT

The present disclosure relates to systems, non-transitory computer-readable media, and methods for generating a digital vector image including strokes based on a digital raster image. In particular, in one or more embodiments, the disclosed systems generate a digital vector image that includes editable, single-lined digital strokes based on strokes from a digital raster image. More specifically, the disclosed systems utilize a stroke identification machine learning model to generate a stroke segmentation map including boundary pixels. Additionally, the disclosed systems generate a digital vector image based on the stroke segmentation map. Accordingly, the disclosed systems generate editable, single-lined digital strokes for the boundary regions of digital objects in the digital raster image.

### BACKGROUND

Vector-based graphics are an important component in many digital graphics environments. Specifically, vector-based graphics provide lossless scaling of images for achieving resolution independence, which is particularly useful in converting digital images to print. Accordingly, vectorization of digital raster images to convert the digital raster image to a digital vector image has many advantages. However, many conventional content management systems inaccurately and inflexibly generate vectorize graphics from digital raster images. These along with additional problems and issues exist with regard to conventional content management systems.

### BRIEF SUMMARY

Embodiments of the present disclosure provide benefits and/or solve one or more of the foregoing or other problems in the art with systems, non-transitory computer-readable media, and methods for generating a digital vector image that includes editable, single-lined digital strokes from a digital raster image. More specifically, in one or more embodiments, the disclosed systems train and utilize a stroke identification machine learning model to generate a stroke segmentation map reflecting boundary pixels of objects portrayed in a digital raster image. Further, in some embodiments, the disclosed systems utilize the stroke segmentation map to generate a digital vector image based on the digital raster image. To illustrate, the disclosed systems generate editable, single-lined digital strokes for the boundary regions of digital objects in a digital raster image.

In some implementations, the disclosed systems train and utilize a stroke identification machine learning model that includes a mix transformer encoder coupled with a multi-scale attention network to accurately extract and refine image features to identify and generate the digital strokes. Additionally, the disclosed systems improve the quality of the stroke identification machine learning model by filtering and diversifying a training dataset. More specifically, the disclosed systems filter images based on stroke contrast and utilize a synthetic data generation pipeline to generate additional digital images for the training dataset that improve variation in image features.

Additional features and advantages of one or more embodiments of the present disclosure are outlined in the description which follows, and in part will be obvious from the description, or may be learned by the practice of such example embodiments.

### BRIEF DESCRIPTION OF THE DRAWINGS

The detailed description provides one or more embodiments with additional specificity and detail through the use of the accompanying drawings, as briefly described below.

FIG. 1 illustrates a diagram of an environment in which a stroke identification system can operate in accordance with one or more embodiments.

FIG. 2 illustrates an overview of the process of generating a digital vector image with digital strokes based on a raster image in accordance with one or more embodiments.

FIG. 3 illustrates a stroke identification machine learning model generating a digital vector image in accordance with one or more embodiments.

FIG. 4 illustrates a process for generating a training dataset of raster images in accordance with one or more embodiments.

FIG. 5 illustrates a process for training a stroke identification machine learning model in accordance with one or more embodiments.

FIG. 6 illustrates the improved results of the stroke identification machine learning model relative to conventional content management systems in accordance with one or more embodiments.

FIG. 7 illustrates a schematic diagram of a stroke identification system in accordance with one or more embodiments.

FIG. 8 illustrates a flowchart of a series of acts for generating a vector image with a single, editable digital stroke in accordance with one or more embodiments.

FIG. 9 illustrates a block diagram of an example computing device for implementing one or more embodiments of the present disclosure.

### DETAILED DESCRIPTION

This disclosure describes one or more embodiments of a stroke identification system that trains and utilizes a stroke identification machine learning model to generate digital vector images from digital raster images. More specifically, in some embodiments, the stroke identification machine learning model generates editable digital strokes for digital vector images based on strokes in digital raster images. To illustrate, in one or more embodiments, the stroke identification system converts a digital raster image depicting a digital object with boundary regions and fill regions into a digital vector image with editable, single-lined digital strokes delineating the boundary regions of the digital object. In some embodiments, the stroke identification system utilizes a stroke identification machine learning model to generate a stroke segmentation map indicating the boundary pixels. Moreover, in one or more embodiments, the stroke identification system utilizes the stroke segmentation map to generate the editable, single-lined digital strokes.

In some embodiments, the stroke identification system accurately converts object boundaries from digital raster images to digital vector strokes utilizing a stroke identification machine learning model. To illustrate, in one or more embodiments, the stroke identification system utilizes a stroke identification machine learning model to generate a stroke segmentation map indicating boundaries of digital objects of a digital raster image. Further, in one or more embodiments, the stroke identification machine learning model generates a digital vector image with editable, single-lined digital strokes based on the stroke segmentation map.

Further, in one or more embodiments, the stroke identification machine learning model includes a multi-scale attention network coupled with a mix transformer encoder. In some embodiments, the stroke identification system pre-trains the mix transformer encoder. Accordingly, in one or more embodiments, the stroke identification machine learning model utilizes the strengths of both convolutional and transformer machine learning architectures and enhances the results with attention machine learning mechanisms.

Additionally, in one or more embodiments, the stroke identification machine learning model utilizes the mix transformer encoder to generate a latent stroke feature representation for a digital raster image. In some embodiments, the latent stroke feature representation includes spatial information and contextual relationships in the digital raster image. In one or more embodiments, the mix transformer encoder processes the digital raster images by extracting hierarchal features at different levels. More specifically, in some embodiments, the mix transformer encoder utilizes a self-attention mechanism to capture spatial relationships and contextual information to generate the latent stroke feature representation.

Further, in some embodiments, the stroke identification machine learning model utilizes a mix transformer encoder to generate a stroke segmentation map based on the latent stroke feature representation. In some embodiments, the multi-scale attention network passes the latent stroke feature representation through attention mechanisms to generate the latent stroke feature representation. Accordingly, the multi-scale attention network refines feature maps iteratively to generate the stroke segmentation map. Thus, in one or more embodiments, the stroke identification machine learning model utilizes the multi-scale attention network and the mix transformer encoder coupled together to generate the stroke segmentation map.

Additionally, in one or more embodiments, the stroke identification system trains the stroke identification machine learning model utilizing a training dataset of raster images. More specifically, in some embodiments, the stroke identification system utilizes a dataset of raster images and corresponding ground-truth vector images. In one or more embodiments, the stroke identification system generates this training dataset by converting a set of digital vector images into digital raster images. Further, in some embodiments, the stroke identification machine learning model filters the digital images for contrast. Additionally, in one or more embodiments, the stroke identification system utilizes a synthetic data generation pipeline to introduce diversity for various image features into the dataset.

Accordingly, in one or more embodiments, the stroke identification system trains the stroke identification machine learning model utilizing the training dataset of raster images. To illustrate, in one or more embodiments, the stroke identification system iteratively trains the stroke identification machine learning model to reduce loss between training digital raster images and corresponding ground-truth vector images. More specifically, in some embodiments, the stroke identification system trains the stroke identification machine learning model utilizing a dice loss function configured for binary mode.

To illustrate, many conventional content management systems vectorize images by converting each boundary of a stroke into two separate lines. Further, the close spacing of these double lines often causes conventional content management systems to generate excessive anchor points. Indeed, these double-lined strokes with excessive anchor points generated by conventional content management systems do not accurately define areas from digital raster images. Accordingly, many conventional content management systems lose the integrity of the design during vectorization.

Further, conventional content management systems are inefficient in their vectorization and consequent editing. As mentioned, many conventional content management systems interpret strokes from digital raster images as double lines with excessive anchor points. Thus, many conventional content management systems are unable to generate a vector image that is editable and changeable without excessive user interaction. Accordingly, conventional content management systems thus complicate or fail to enable further editing by requiring user interaction and management of two mathematically separate lines for any line from a digital raster image. Thus, modification of any lines, shapes, or fill in the double-lined renderings require precise modification of separately stored vector paths to maintain parallel curves or lines, or intersections of various paths. This inefficient processing of excessive separate assets makes modification consume excessive time and computing resources.

The stroke identification system provides many advantages and benefits over conventional systems and methods. For example, by utilizing a stroke identification machine learning model that extracts single-lined digital strokes from raster images, the stroke identification system improves accuracy relative to conventional systems. Specifically, the stroke identification system utilizes the stroke identification machine learning model to accurately identify strokes from a raster image and vectorize those strokes as single-lined, editable digital strokes in a vector image. To illustrate, by coupling a multi-scale attention network with a mix transformer encoder, the stroke identification machine learning model provides more accurate vectorization of digital strokes.

Moreover, the stroke identification system also improves efficiency relative to conventional systems. To illustrate, by generating single-lined, editable digital strokes, the stroke identification system generates efficiently editable digital vector images. Further, single-lined, editable digital strokes reduce or eliminate excessive user interactions to modify the digital vector image because the single-lined, editable digital strokes are easy to modify and edit. Thus, the stroke identification system generates an efficient digital vector image that can easily change based on user input. For example, conventional systems double-lined output can make adding fill to a digital object very imprecise, with fill only covering the area between the double lines. By rendering strokes as single-lined, editable digital strokes, the stroke identification machine learning model allows efficient and accurate modification of strokes or fill of digital objects delineated by digital strokes.

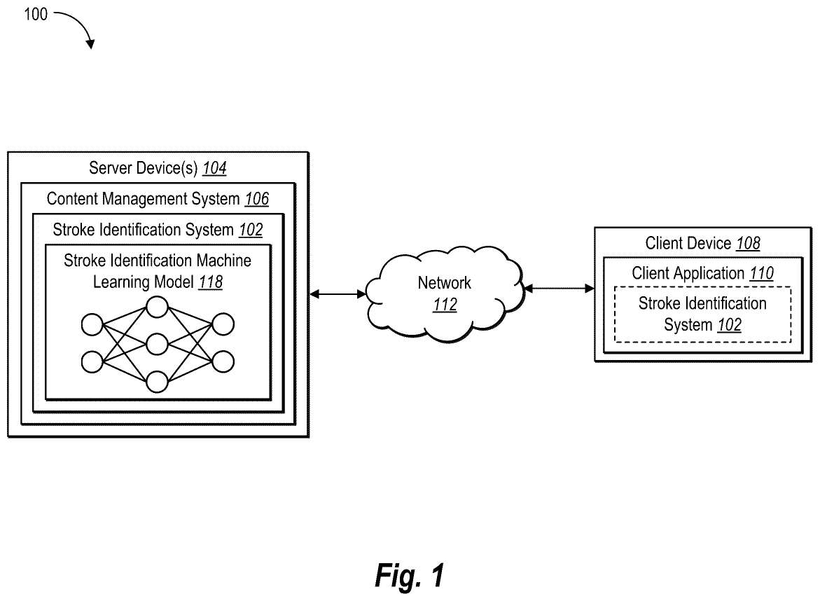

Additional detail regarding the stroke identification system will now be provided with reference to the figures. For example, FIG. 1 illustrates a schematic diagram of an example system environment 100 for implementing a stroke identification system 102 in accordance with one or more embodiments. An overview of the stroke identification system 102 is described in relation to FIG. 1. Thereafter, a more detailed description of the components and processes of the stroke identification system 102 is provided in relation to the subsequent figures.

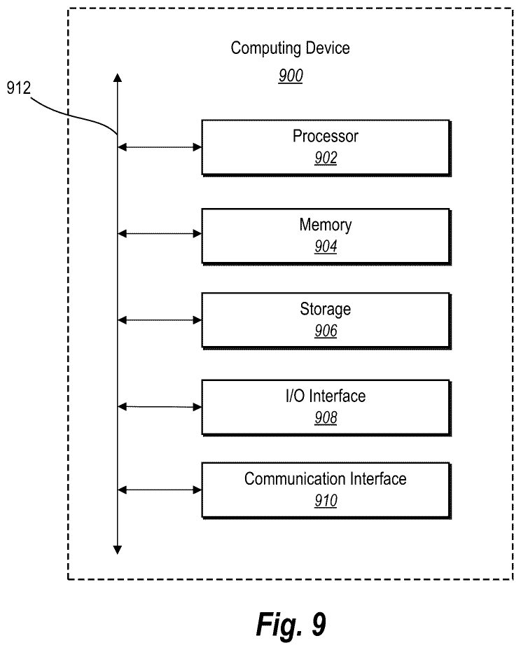

As shown, the environment includes server device(s) 104, a client device 108, and a network 112. Each of the components of the environment communicate via the network 112, and the network 112 is any suitable network over which computing devices communicate. Example networks are discussed in more detail below in relation to FIG. 9.

As mentioned, the environment includes a client device 108. The client device 108 is one of a variety of computing devices, including a smartphone, a tablet, a smart television, a desktop computer, a laptop computer, a virtual reality device, an augmented reality device, or another computing device as described in relation to FIG. 9. Although FIG. 1 illustrates a single instance of the client device 108, in some embodiments, the environment includes multiple different client devices, each associated with a different user. The client device 108 communicates with the server device(s) 104 and/or the content management system 106 via network 112. For example, the client device 108 receives information from the server device(s) 104 and provides information to server device(s) 104 relating to digital images.

In one or more embodiments, a digital image includes a digital file with visual information. To illustrate, a digital image can be stored in a file format such as SVG, EPS, or PDF. A digital raster image includes a digital image defined by visual characteristics of individual pixels. Thus, a digital raster image includes an image composed of a grid of pixels arranged in rows and columns. Each pixel has its own color and intensity, and when viewed, these pixels combine to form a coherent image. Furthermore, in one or more embodiments, a digital image portrays digital objects and/or or text.

A digital vector image refers to an image that uses formulas to define lines, shapes, and colors (rather than a grid of pixels like raster images). Because vector images are based on geometric elements such as points, lines, curves, and polygons, they can be scaled without losing quality or becoming pixelated. Thus, a digital vector image includes to a digital image that includes content represented via one or more digital strokes (e.g., curves or lines) stored as vector paths directing the route and shape of the digital stroke.

Additionally, in one or more embodiments, a digital stroke includes a digital curve or line defined by one more formulas. In one or more embodiments, a digital stroke corresponds to one or more digital objects (e.g., a curve defining the border of a person, place, or thing). For example, a digital stroke includes a vector path defined by a plurality of points (e.g., a start point and an end point). In some embodiments, a digital stroke also includes curve or line information (e.g., via one or more handles or anchor points) indicating a curve or line intersecting the points. For example, in one or more embodiments, a digital stroke includes a cubic Bezier path or a non-Bezier path (e.g., a straight line) from a start point to an end point. In additional embodiments, digital vector images include another type of path such as, but not limited to, Hermite curves, B-splines, non-uniform rational basis splines, Kappa-curves, or Catmull-Rom splines.

As shown in FIG. 1, the client device 108 includes a client application 110. In particular, the client application 110 is a web application, a native application installed on the client device 108 (e.g., a mobile application or a desktop application), or a cloud-based application where all or part of the functionality is performed by the server device(s) 104. The client application 110 presents or displays information to a user, including a content editing interface for modifying digital strokes in a digital vector image.

As also illustrated in FIG. 1, the environment includes the server device(s) 104. The server device(s) 104 generates, tracks, stores, processes, receives, and transmits electronic data, such as digital images. For example, the server device(s) 104 receives data from the client device 108 in the form of a digital raster image. In response, the server device(s) 104 provides data to the client device 108 in the form of a digital vector image, as described herein. For example, the server device(s) 104 access a trained neural network, such as a stroke identification machine learning model 118, to generate and provide the denoised digital image to the client device 108.

For example, a machine learning model includes a computer algorithm or a collection of computer algorithms that automatically improve for a particular task through iterative outputs or predictions based on use of data. To illustrate, a machine learning model utilizes one or more learning techniques to improve in accuracy and/or effectiveness. Example machine learning models include various types of neural networks, decision trees, support vector machines, linear regression models, and Bayesian networks.

Along these lines, a neural network refers to a machine learning model that is trained and/or tuned based on inputs to generate digital content such as text and images, and to determine classifications, scores, or approximate unknown functions. For example, a neural network includes a model of interconnected artificial neurons (e.g., organized in layers) that communicate and learn to approximate complex functions and generate outputs (e.g., information flow patterns) based on a plurality of inputs provided to the neural network. In some cases, a neural network refers to an algorithm (or set of algorithms) that implements deep learning techniques to model high-level abstractions in data. In some embodiments, a neural network includes various layers such as an input layer, one or more hidden layers, and an output layer that each perform tasks for processing data. For example, a neural network includes a deep neural network, a convolutional neural network, a recurrent neural network (e.g., an LSTM), a graph neural network, a transformer neural network, a diffusion neural network, a multi-scale attention network, or a large language model.

Further, a stroke identification machine learning model refers to a machine learning model that vectorizes digital raster images. To illustrate, in one or more embodiments, a stroke identification machine learning model generates vector images including single-lined, editable digital strokes based on raster images. Additionally, in some embodiments, a stroke identification machine learning model refers to a multi-scale attention network coupled with a mix transformer encoder.

A multi-scale attention network includes a type of neural network architecture that captures and processes information at multiple spatial or temporal scales. For example, a multi-scale attention network includes a convolutional neural network having an attention mechanism that allows the network to focus on different parts of the input data selectively (e.g., by assigning weights to different regions or features, helping the model emphasize important parts while downplaying irrelevant ones). A muti-scale attention network can analyze the input at various scales or resolutions that allows the network to capture both local details (small-scale) and global structure (large-scale). By combining information at different scales, the network can form a hierarchical representation of the input, improving performance.

Similarly, a mix transformer includes a neural network architecture that is a variant of a transformer architecture that processes images at multiple scales. In particular, a mix transformer can process images at multiple scales by splitting them into patches of varying sizes, allowing the model to capture both local and global features. The mix transformer can utilize self-attention mechanisms to model long-range dependencies between pixels, providing an efficient way to handle large images with minimal positional encoding. Additional detail regarding multi-scale attention networks and mix transformer networks is provided below.

In some embodiments, the server device(s) 104 communicates with the client device 108 to transmit and/or receive data via the network 112. In some embodiments, the server device(s) 104 comprises a distributed server where the server device(s) 104 includes a number of server devices distributed across the network 112 and located in different physical locations. The server device(s) 104 comprise a content server, an application server, a communication server, a web-hosting server, a multidimensional server, or a machine learning server.

As further shown in FIG. 1, the server device(s) 104 also includes the stroke identification system 102 as part of a content management system 106. For example, in one or more implementations, the content management system 106 stores, generates, modifies, edits, enhances, provides, distributes, and/or shares digital content, such as digital images. For example, the content management system 106 provides digital content for editing or other forms of digital processing. In some implementations, the content management system 106 provides digital content to particular digital profiles associated with client devices (e.g., the client device 108).

In one or more embodiments, the server device(s) 104 includes all, or a portion of, the stroke identification system 102. For example, the stroke identification system 102 operates on the server device(s) 104 to extract strokes from digital images and/or train the stroke identification machine learning model 118. In some embodiments, the client device 108 includes all or part of the stroke identification system 102. Indeed, in some implementations, as illustrated in FIG. 1, the stroke identification system 102 is located in whole or in part of the client device 108 (e.g., as part of the client application 110). For example, the stroke identification system 102 includes a web hosting application that allows the client device 108 to interact with the server device(s) 104. To illustrate, in one or more implementations, the client device 108 accesses a web page supported and/or hosted by the server device(s) 104.

In one or more embodiments, the client device 108 and the server device(s) 104 work together to train and/or implement models of the stroke identification system 102. For example, in some embodiments, the server device(s) 104 train one or more neural networks (e.g., the stroke identification machine learning model 118) and provide the one or more neural networks to the client device 108 for implementation. In some embodiments, the client device trains one or more neural networks (e.g., individually or together with the server device(s) 104).

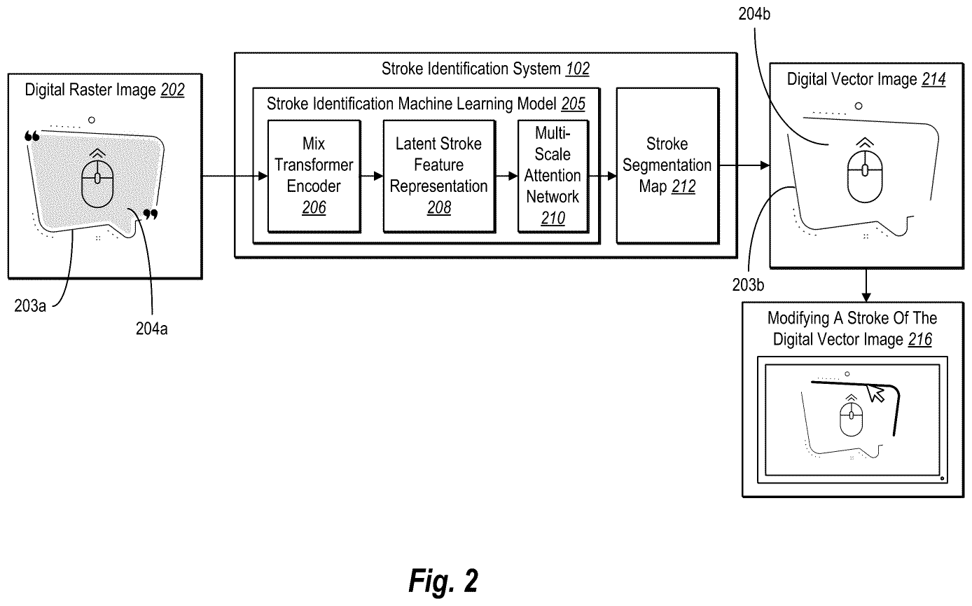

As discussed above, the stroke identification system 102 can generate digital vector images from digital raster images. For instance, FIG. 2 illustrates the system utilizing a stroke identification machine learning model to generate a digital vector image based on a digital raster image in accordance with one or mor embodiments. Specifically, FIG. 2 shows a digital raster image 202 including a boundary region of boundary pixels 203a and a fill region of fill pixels 204a. In one or more embodiments, the boundary region of boundary pixels 203a includes pixels that are part of a digital stroke. Further, in some embodiments, the fill region of fill pixels 204a includes pixels that are shaded in a color or shade on the interior of a digital object.

As shown in FIG. 2, the digital raster image 202 is a graphic of a computer mouse with various digital strokes. Specifically, the digital raster image 202 includes the boundary region of boundary pixels 203a of a line around a speech bubble shape. Further, the digital raster image 202 includes the fill region of fill pixels 204a that are shaded in with a diffusion of the shade around the upper right hand corner of the image.

As also shown in FIG. 2, the stroke identification system 102 receives the digital raster image 202 and utilizes the stroke identification machine learning model 205 to process the digital raster image 202. In one or more embodiments, the stroke identification machine learning model includes a mix transformer encoder 206 coupled with a multi-scale attention network 210. In one or more embodiments, the stroke identification system 102 pre-trains the mix transformer encoder 206. By coupling the mix transformer encoder 206 with the multi-scale attention network 210, the stroke identification machine learning model 205 leverages the strengths of both convolutional and transformer architectures enhanced by attention mechanisms. More specifically, the multi-scale attention network 210 integrates advanced attention mechanisms, including spatial and channel attention. Further, the mix transformer encoder 206 extracts image features for refinement.

To illustrate, the stroke identification system 102 feeds the digital raster image 202 into the stroke identification machine learning model 205 with three RGB (red green blue) channels. The stroke identification machine learning model 205 utilizes the mix transformer encoder 206 to process through its encoder to extract hierarchal features at different levels. Further, in one or more embodiments, the mix transformer encoder 206 utilizes a self-attention mechanism to capture image data including spatial relationships and contextual information. In some embodiments, the stroke identification machine learning model 205 packages this image data as a latent stroke feature representation 208.

In one or more embodiments, the mix transformer encoder 206 combines local feature extraction capabilities of a convolutional neural network with the global context modeling of vision transformers. In some embodiments, the mix transformer encoder 206 is pre-trained on large-scale datasets. Accordingly, in one or more embodiments, the mix transformer encoder 206 captures diverse and hierarchal features from digital images to generate the latent stroke feature representation 208. For example, in some implementations, the stroke identification system 102 utilizes a pre-trained Mix Transformer B3 (MIT-B3) encoder architecture. Indeed, this architecture combines the local feature extraction capabilities of Convolutional Neural Networks (CNNs) with the global context modeling of Vision Transformers (ViTs). This encoder is pre-trained on largescale datasets, enabling it to capture diverse and hierarchical features from the input images.

As shown in FIG. 2, in one or more embodiments, the stroke identification machine learning model 205 passes the latent stroke feature representation 208 from the mix transformer encoder 206 to the multi-scale attention network 210. In some embodiments, the stroke identification machine learning model 205 passes the latent stroke feature representation 208 through attention mechanisms integrated into the multi-scale attention network 210 architecture. In one or more embodiments, the attention mechanisms highlight digital image features relevant to digital strokes and suppress digital image features irrelevant to digital strokes. Accordingly, in some embodiments, the multi-scale attention network 210 utilizes these attention mechanisms to generate and refine a feature map that identifies digital stroke shape and segmentation.

Additionally, in one or more embodiments, the multi-scale attention network 210 utilizes a decoder to decode the feature map. To illustrate, the decoder decodes a feature map to generate a stroke segmentation map 212. More specifically, in some embodiments, the multi-scale attention network 210 utilizes a decoder to up-sample a feature map to match an original input resolution of the digital raster image 202.

Further, in one or more embodiments, the multi-scale attention network 210 utilizes the decoder to generate the stroke segmentation map 212 as a pixel-wise classification map. To illustrate, the multi-scale attention network 210 determines pixel values for each pixel in the digital raster image indicating probabilities of belonging to a stroke foreground class or a stroke background class. Specifically, the multi-scale attention network 210 generates a feature map and refines the feature map through attention mechanisms. Additionally, the multi-scale attention network 210 utilizes a decoder to decode and up-sample the feature map to generate a stroke segmentation map 212 that includes refined pixel values for each pixel in the digital raster image indicating probabilities of belonging to a stroke foreground class or a stroke background class.

As also shown in FIG. 2, the stroke identification system 102 utilizes the stroke segmentation map 212 to generate a digital vector image 214. To illustrate, the stroke identification machine learning model utilizes the pixels indicating probabilities of belonging to a stroke foreground class to generate digital strokes. As shown in FIG. 2, the stroke identification system 102 generates the digital vector image 214 including digital strokes from the digital raster image 202. For example, the single-lined, editable digital stroke 203b follows the curves and paths indicated by the digital stroke 203b. However, in one or more embodiments, the stroke identification system 102 generates the digital vector image 214 without fill. Accordingly, the digital vector image 214 does not include shape fill at the area 204b. Moreover, the stroke identification system 102 generates the digital stroke 203b to preserve the visual characteristics from the digital raster image 202. For example, the stroke identification system 102 selects a stroke thickness to match the width of pixels in the stroke segmentation map 212.

In one or more embodiments, vector graphics include lines and curves defined by mathematical vectors that precisely describe the strokes of the digital vector image based on geometric properties. Accordingly, in one or more embodiments, digital vector images maintain sharp edges and do not lose detail when resized, as the mathematical vectors are stored independent of a resolution. In some embodiments, strokes in digital vector image include segments and anchor points. Indeed, in one or more embodiments, the structure of a digital stroke is made up of a chain of path segments, each of which is a Bezier curve. In some embodiments, segments are the lines or curves that connect anchor points, and anchor points determine the start and end points of each stroke segment. Further, in one or more embodiments, anchor points are points in a digital stroke that control its shape and direction.

Further, in one or more embodiments, digital vector images include shapes that include a path, a stroke, and a fill. In some embodiments, a path defines an area that can be filled with color or gradients to generate or enhance a visual presence. Further, in one or more embodiments, a fill applies a color or gradient to the area inside a path, while a digital stroke outlines the path.

In some embodiments, digital strokes are the outlines or paths that define the contours of digital objects and other graphic elements. Digital strokes can include lines, curves, or edges. Further, in one or more embodiments, a digital stroke includes visual effects affixed to paths. In one or more embodiments, digital strokes vary in thickness, color, size, and style. Further, in one or more embodiments, digital strokes outline shapes, create borders, emphasize elements, denote lettering or typography, and/or define the edges of illustrations or icons. In some embodiments, strokes are continuous. In addition, or in the alternative, in one or more embodiments, strokes are a periodic series of dashes and gaps.

As also shown in FIG. 2, the stroke identification system 102 can perform an act 216 of modifying a stroke of the digital vector image. More specifically, the stroke identification system 102 receives user input indicating that a digital stroke should be made thicker and modifies the digital stroke accordingly. Similarly, the stroke identification system 102 can modify position, alignment, rotation, curvature, or color of a digital stroke. Furthermore, the stroke identification system 102 can add fill within an area encompassed by a digital vector stroke. It will be appreciated that the stroke identification system 102 and/or the content management system 106 can facilitate a variety of types of modification to a variety of digital strokes.

As mentioned above, in one or more embodiments, digital vector images include editable and changeable digital strokes. To illustrate, the stroke identification system 102 can modify the shape of a digital stroke by adjusting its vertices or directional handles located at the ends of tangent lines associated with each vertex. Further, in some embodiments, the stroke identification system 102 can modify the shape of a digital stroke by modifying one or more segments of a digital stroke. In some embodiments, the stroke identification system 102 renders a digital stroke visible as a line of an indicated width following the path of the handles, anchor points, and segments.

In one or more embodiments, the stroke identification system 102 provides graphical user interfaces for editing digital vector images. For example, a client device displays a graphical user interface for modifying the digital vector image 214 including generating, editing, and deleting paths or segments within the digital vector image 214. To illustrate, the client device displays tools for generating and editing a stroke along a path in the digital vector image 214, including determining attributes such as line weight or stroke type.

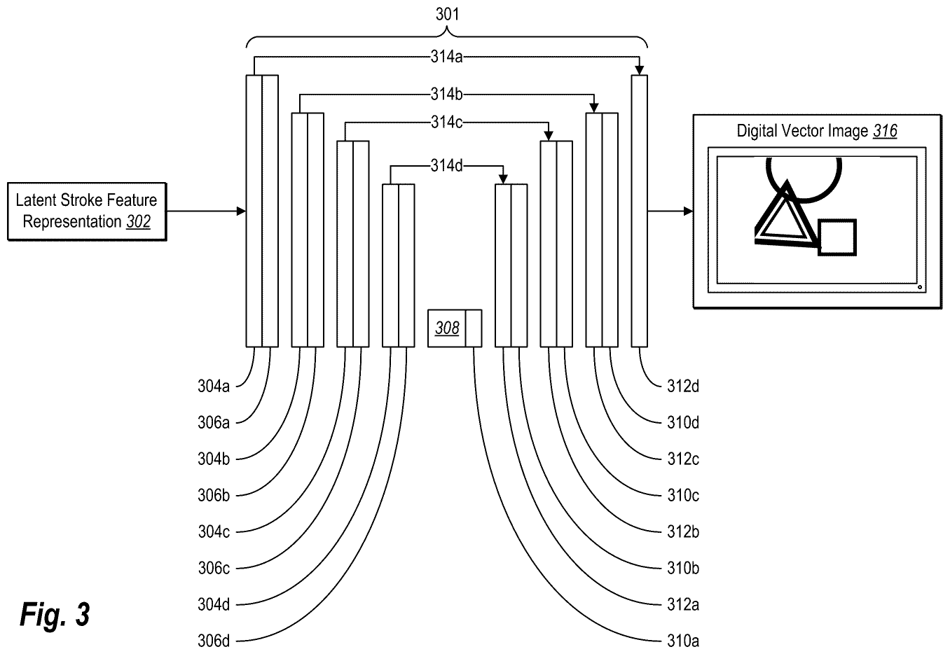

As mentioned above, in one or more embodiments, the stroke identification machine learning model includes a multi-scale attention network coupled with a mix transformer encoder. FIG. 3 illustrates architecture of a multi-scale attention network 301 in accordance with one or more embodiments. To illustrate, FIG. 3 shows that the stroke identification system 102 can utilize the multi-scale attention network 301 to process a latent stroke feature representation 302 and generate a digital vector image 316 including strokes from the latent stroke feature representation 302. In addition, or in the alternative, the multi-scale attention network 301 generates a stroke segmentation map, which the stroke identification system 102 utilizes to generate the digital vector image 316.

In one or more embodiments, the multi-scale attention network 301 is a deep learning model used for image segmentation with a dual attention mechanism. In some embodiments, the multi-scale attention network 301 integrates multiple attention mechanisms to enhance image feature representations. More specifically, in one or more embodiments, the multi-scale attention network 301 leverages spatial and channel attention to dynamically focus on the most relevant parts of a digital image. Thus, in one or more embodiments, the multi-scale attention network 301 improves performance in distinguishing between different regions of an image. Indeed, in one or more embodiments, the multi-scale attention network 301 utilizes this mechanism to distinguish between regions of a digital raster image that are relevant to digital strokes and regions of a digital raster image that are not relevant to digital strokes.

As shown in FIG. 3, the multi-scale attention network 301 includes residual connection blocks 304a-304d. In one or more embodiments, the residual connection blocks 304a-304d are coupled with three-by-three convolutional blocks 306a-306d. In one or more embodiments, the residual connection blocks 304a-304d and the three-by-three convolutional blocks 306a-306d iteratively capture high-dimensional feature information from the latent stroke feature representation 302. Further, as shown in FIG. 3, the residual connection blocks 304a-304d utilize skip connections 315a-314d to pass data to the multi-scale fusion attention blocks 312a-312d.

As also shown in FIG. 3, the multi-scale attention network 301 includes two blocks with self-attention mechanisms. More specifically, the multi-scale attention network 301 includes a position-wise attention block 308 and the multi-scale fusion attention blocks 312a-312d. In one or more embodiments, the multi-scale attention network 301 utilizes the position-wise attention block 308 and the multi-scale fusion attention blocks 312a-312d to capture attention feature maps of spatial and channel levels. Further, in some embodiments, the position-wise attention block 308 obtains special dependencies between pixels in a global view. Additionally, in one or more embodiments, the multi-scale fusion attention blocks 312a-312d capture channel dependencies between feature maps by fusing high-level and low-level semantic features.

As also shown in FIG. 3, in one or more embodiments, the position-wise attention block 308 is coupled with an up-sampling block 310a. Further, as shown in FIG. 3, in some embodiments, the multi-scale fusion attention blocks 312a-312c are coupled with up-sampling blocks 310b-310d. In one or more embodiments, the up-sampling blocks 310a-310d up-sample the capture attention feature maps captured by the position-wise attention block 308 and the multi-scale fusion attention blocks 312a-312d. In one or more implementations, the stroke identification system 102 utilizes a MA-Net architecture for the multi-scale attention network.

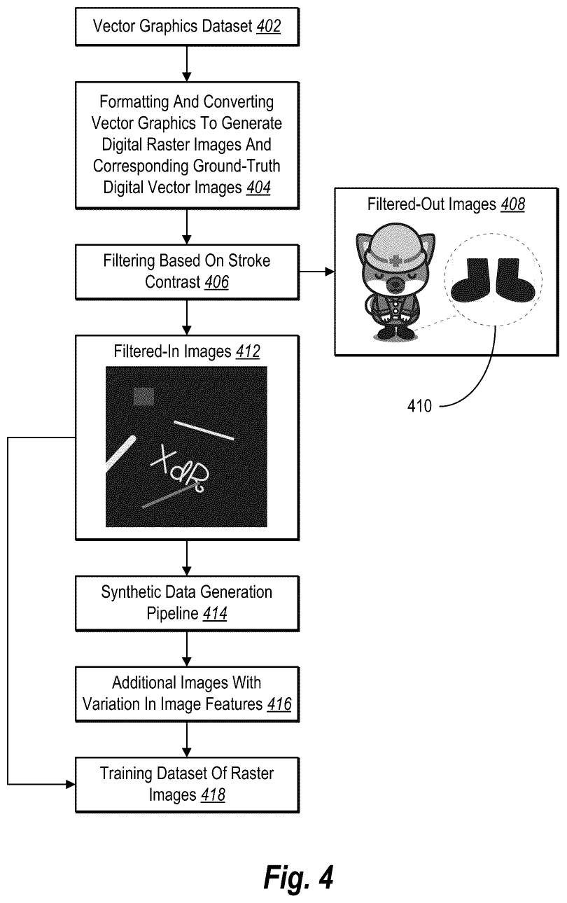

As mentioned above, in one or more embodiments, the stroke identification system 102 generates a training dataset of raster images to train the stroke identification machine learning model. FIG. 4 illustrates a process for generating that training dataset in accordance with one or more embodiments.

To illustrate, as shown in FIG. 4, in one or more embodiments, the stroke identification system 102 accesses a vector graphics dataset 402 and performs an act 404 of formatting and converting vector graphics to generate digital raster images and corresponding ground-truth digital vector images. In some embodiments, the stroke identification system 102 rasterizes the digital vector images by converting the digital vector images to a PNG format. The stroke identification system 102 can extract vectors from the digital vector images (e.g., for ground truth Accordingly, the stroke identification system 102 can mark the digital raster image and digital vector image pairs as training input and corresponding ground-truth.

As also shown in FIG. 4, the stroke identification system 102 performs an act 406 of filtering based on stroke contrast. Specifically, as shown in FIG. 4, the stroke identification system 102 sorts the digital images into filtered-out images 408 or filtered-in images 412. In one or more embodiments, the stroke identification system 102 filters out digital vector images with insufficient contrast between stroke regions and other regions (e.g., fill regions) to enhance visibility and distinguishability of stroke patterns.

For example, as shown in FIG. 4, a digital vector image is included in the filtered-out images 408 due to a poor contrast region 410. To illustrate, the poor contrast region 410 has insufficient contrast between the fill for shoes and the stroke for the shoes. This causes the strokes on the boots to almost blend into the fill, and accordingly the stroke identification system 102 sorts the digital image including the poor contrast region into the filtered-out images 408. In one or more embodiments, the stroke identification system 102 determines contrast values between digital objects in digital images. Accordingly, in some embodiments, the stroke identification system 102 can apply a contrast threshold to the contrast values and exclude any digital image with at least one contrast value that does not satisfy the contrast threshold.

Additionally, as shown in FIG. 4, the stroke identification system 102 utilizes a synthetic data generation pipeline 414 to generate additional images with variation in image features 416. More specifically, in one or more embodiments, the synthetic data generation pipeline 414 utilizes the filtered-in images to determine image features that are not present in the dataset. In one or more embodiments, the synthetic data generation pipeline 414 generates both a digital raster image and a corresponding digital vector image with the strokes from the digital raster image.

For example, the synthetic data generation pipeline 414 can identify a low percentage of digital images in the training dataset that have parallel lines, lines meeting at acute angles, solid shapes, parallel shapes (e.g., lines, triangles, rectangles, ellipses), shapes with shadows, wheels, fonts, checkerboard patterns, or other complex shapes. Accordingly, in one or more embodiments, the synthetic data generation pipeline 414 augments the training dataset with instances that the stroke identification machine learning model is likely to encounter in real-world applications, but that are underrepresented in the training dataset. For example, the stroke identification system 102 can utilize synthetic digital images with parallel lines (e.g., to train the model to distinguish between single-line strokes and parallel shapes in digital images). Thus, the stroke identification system 102 can better train the model to generalize better and perform more accurately on real-world images.

The stroke identification system 102 can select parallel shapes, such as parallel lines, because some strokes in real-world scenarios are parallel to each other, sometimes with no gap in between. Including these in the dataset helps the model learn to differentiate between two closely situated strokes and treat them appropriately, improving its accuracy in recognizing and classifying different strokes. Diverse solid shapes and checkerboard patterns were introduced to enhance the model's ability to recognize and differentiate between complex patterns. Shapes with shadows and stroke-like fonts were included to simulate real-world variations in lighting and font styles. Shadows can affect the appearance of shapes, making edges less distinct and introducing variations in pixel intensity.

However, in one or more embodiments, the stroke identification system 102 can further filter the output of the synthetic data generation pipeline 414. For example, the stroke identification system 102 can apply quality filters to identify images that will improve performance of the model. In one or more embodiments, the stroke identification system 102 classifies the digital raster image output of the synthetic data generation pipeline 414 as having only strokes, having no strokes, or having both strokes and non-stroke components. In some embodiments, the stroke identification system 102 excludes digital raster images having only strokes or having no strokes from the training dataset, and only provides digital images having both strokes and non-stroke components to the training dataset.

Further, as shown in FIG. 4, in one or more embodiments, the stroke identification system 102 combines digital images from the filtered-in images 412 and the additional images with variation in image features 416. More specifically, the stroke identification system 102 utilizes the digital raster images as a training dataset with the corresponding digital vector images as ground-truth data.

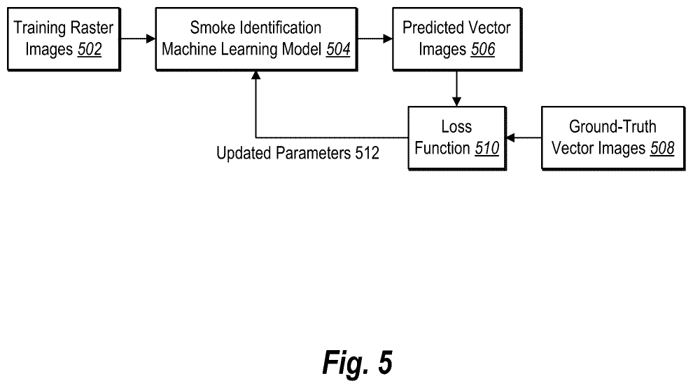

Additionally, in one or more embodiments, the stroke identification system 102 utilizes the training dataset of raster images to train the stroke identification machine learning model. FIG. 5 illustrates an overview of the process of training a stroke identification machine learning model. To illustrate, as shown in FIG. 5, the stroke identification system 102 provides training raster images 502 to the stroke identification machine learning model 504.

As also shown in FIG. 5, the stroke identification machine learning model 504 generates predicted vector images 506 (e.g., predicted vector strokes). Further, as shown in FIG. 5, the stroke identification system 102 compares the predicted vector images 506 and ground-truth vector images 508 utilizing a loss function 510. In one or more embodiments, the loss function 510 includes a dice loss function configured for binary mode and applied from logits. Dice loss handles class imbalance by focusing on the overlap between predicted and true segmentation rather than raw pixel-wise accuracy. In some embodiments, dice loss measures the overlap between the predicted and target segmentation masks (i.e., predicted stroke pixels and actual stroke pixels). In one or more embodiments, the dice loss function can mitigate the imbalance problem of background and foreground pixels.

Where y represents the true stroke segmentation of a digital image, and p represents the predicted stroke segmentation generated by the stroke identification machine learning model, dice loss can be determined by the following Formula 1.

$$DiceLoss ( y , p ) = 1 - \frac{2 yp + 1}{y + p + 1} \qquad ( 1 )$$

Based on the loss from the loss function 510, the stroke identification system 102 determines updated parameters 512 for the stroke identification machine learning model 504. For example, the stroke identification system 102 can utilize back propagation and gradient descent to modify parameters of the stroke identification machine learning model 504. Accordingly, the stroke identification system 102 can iteratively train the stroke identification machine learning model 504 to generate accurate digital strokes for digital vector images by performing additional training iterations until the loss from the loss function 510 is sufficiently minimized.

Although the foregoing example references a particular type of loss function, in some implementations, the stroke identification system 102 utilizes a variety of different loss functions. For example, in some embodiments, the stroke identification system 102 utilizes a cross-entropy loss (e.g., binary cross entropy loss), a hinge loss, intersection over union, focal loss, or Tversky loss.

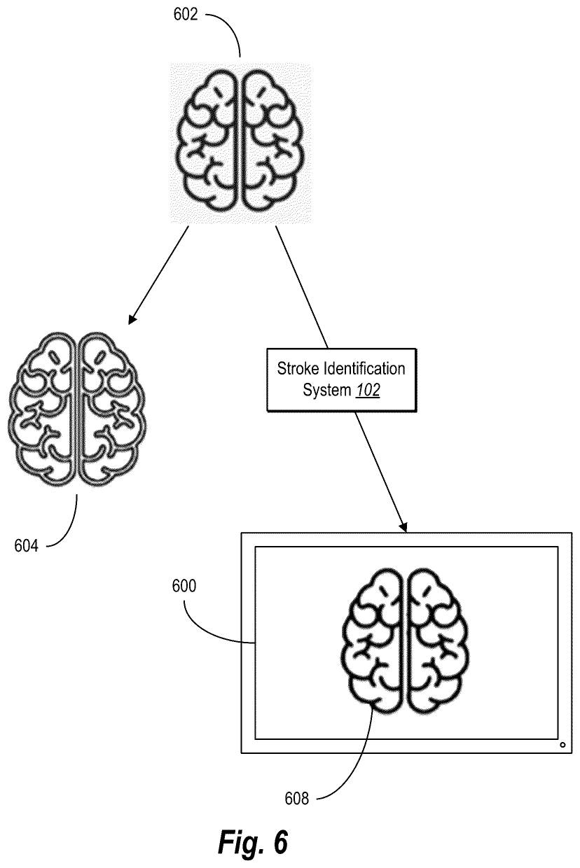

As mentioned above, the stroke identification machine learning model shows high robustness across various types of strokes, and effectively detects different styles. To illustrate, the stroke identification machine learning model detects different gradient strokes, ensures that fills are accurately distinguished from strokes, and thereby enhances the accuracy of digital image vectorization. FIG. 6 illustrates the results of the stroke identification system 102 relative to conventional systems.

As shown in FIG. 6, the digital raster image 602 depicts an illustration of a brain. However, conventional systems often vectorize the digital raster image 602 as the inaccurate vector image 604, which renders each stroke from the digital raster image 602 as a double line. Manipulating both lines separately renders editing of the inaccurate vector image 604 extremely inefficient and difficult. Further, the double lines also cause the inaccurate vector image 604 to include excessive anchor points, which further amplifies the computational inefficiency of editing the inaccurate vector image 604.

In contrast, when the stroke identification system 102 processes the digital raster image 602, the stroke identification system 102 generates a digital vector image 600 that includes single-lined, editable digital strokes 608. By identifying and tracing the single lined, editable digital strokes 608, the stroke identification system 102 speeds up the vectorization process and reduces or eliminates excessive user interactions required to edit the inaccurate vector image 604. Further, the stroke identification system 102 accommodates various stroke styles and complexities, which enhances the versatility of editing tools upon generation of the digital vector image 600.

Each of the components 702-712 of the stroke identification system 102 can include software, hardware, or both. For example, the components 702-712 can include one or more instructions stored on a computer-readable storage medium and executable by processors of one or more computing devices, such as a client device or server device. When executed by the one or more processors, the computer-executable instructions of the stroke identification system 102 can cause the computing device(s) to perform the methods described herein. Alternatively, the components 702-712 can include hardware, such as a special-purpose processing device to perform a certain function or group of functions. Alternatively, the components 702-712 of the stroke identification system 102 can include a combination of computer-executable instructions and hardware.

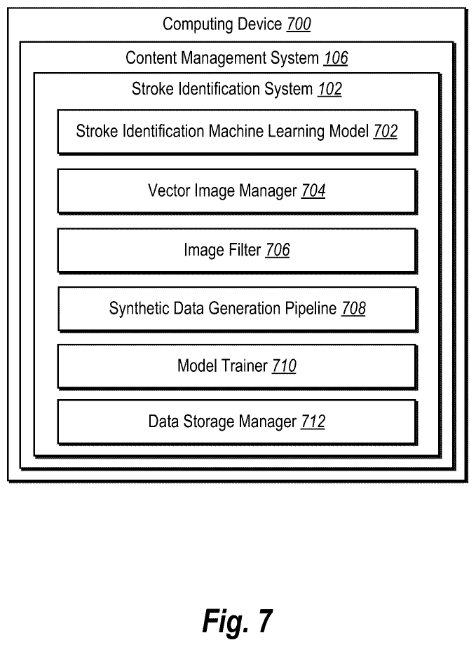

Furthermore, the components 702-712 of the stroke identification system 102 may, for example, be implemented as one or more operating systems, as one or more stand-alone applications, as one or more modules of an application, as one or more plug-ins, as one or more library functions or functions that may be called by other applications, and/or as a cloud-computing model. Thus, the components 702-712 may be implemented as a stand-alone application, such as a desktop or mobile application. Furthermore, the components 702-712 may be implemented as one or more web-based applications hosted on a remote server. The components 702-712 may also be implemented in a suite of mobile device applications or “apps.” As shown in FIG. 7, in one or more embodiments, the computing device 700 includes the content management system 106, which in turn includes the stroke identification system 102.

As shown in FIG. 7, the stroke identification system 102 includes a stroke identification machine learning model 702. In one or more embodiments, the stroke identification machine learning model 702 generates digital vector images including digital strokes based on digital raster images. In some embodiments, the stroke identification machine learning model 702 includes a multi-scale attention network coupled with a mix transformer encoder. In some embodiments, the stroke identification machine learning model 702 generates latent stroke feature representations and/or stroke segmentation maps. Further, in one or more embodiments, the stroke identification machine learning model 702 utilizes attention mechanisms to refine stroke segmentation maps.

As also shown in FIG. 7, the stroke identification system 102 includes a vector image manager 704. In one or more embodiments, the vector image manager 704 facilitates editing of digital vector images. To illustrate, in some embodiments, the vector image manager 704 receives and implements user input indicating modifications to digital vector images, including user input indicating modifications to digital strokes.

Additionally, as shown in FIG. 7, the stroke identification system 102 includes an image filter 706. In one or more embodiments, the image filter 706 filters digital images in a training dataset of raster images. To illustrate, in some embodiments, the image filter 706 filters images out of the training dataset by identifying images with insufficient contrast and removing those images from the dataset.

Further, in one or more embodiments, the stroke identification system 102 includes a synthetic data generation pipeline 708. In one or more embodiments, the synthetic data generation pipeline 708 generates additional digital raster images and corresponding digital vector images for a training dataset. To illustrate, in some embodiments, the synthetic data generation pipeline 708 identifies one or more digital image features that are lacking in the training dataset. Further, the synthetic data generation pipeline 708 generates additional digital raster images and corresponding digital vector images based on the identified digital image features. Accordingly, the additional digital raster images and corresponding digital vector images can add the additional digital images to the training dataset to supplement and diversify the training dataset.

Additionally, in one or more embodiments, the stroke identification system 102 includes a model trainer 710. In one or more embodiments, the model trainer 710 trains the stroke identification machine learning model 702. In some embodiments, the model trainer 710 utilizes a dice loss function configured for binary mode and applied from logits.

The stroke identification system 102 further includes a data storage manager 712. The data storage manager 712 operates in conjunction with, or includes, one or more memory devices such as a database that store various data such as digital images, such as digital raster images and digital vector images. In one or more embodiments, the data storage manager 712 stores the digital vector images and digital raster images accessible and usable by other components of the stroke identification system 102. In some cases, the data storage manager 712 also stores the stroke identification machine learning model 702 accessible and usable by other components of the stroke identification system 102. The data storage manager 712 communicates with the other components of the stroke identification system 102 to facilitate the operations and functions described herein.

Furthermore, the components of the stroke identification system 102 performing the functions described herein may, for example, be implemented as part of a stand-alone application, as a module of an application, as a plug-in for applications including content management applications, as a library function or functions that may be called by other applications, and/or as a cloud-computing model. Thus, the components of the stroke identification system 102 may be implemented as part of a stand-alone application on a personal computing device or a mobile device. Alternatively, or additionally, the components of the stroke identification system 102 may be implemented in any application that allows creation and delivery of marketing content to users, including, but not limited to, applications in ADOBE® EXPERIENCE MANAGER and CREATIVE CLOUD®, such as ADOBE® PHOTOSHOP®, ILLUSTRATOR®, and INDESIGN®. “ADOBE,” “ADOBE EXPERIENCE MANAGER,” “CREATIVE CLOUD,” “PHOTOSHOP,” “ILLUSTRATOR,” and “INDESIGN” are either registered trademarks or trademarks of Adobe Inc. in the United States and/or other countries.

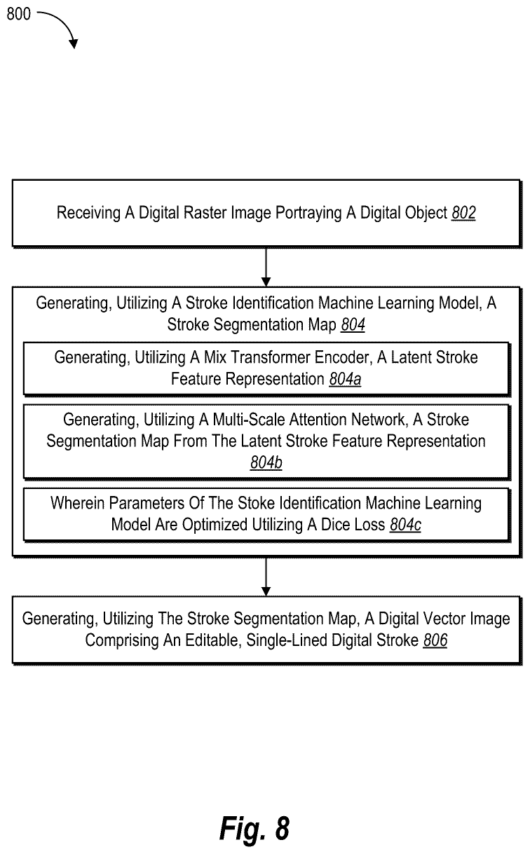

FIGS. 1-7, the corresponding text, and the examples provide a number of different methods, systems, devices, and non-transitory computer-readable media of the stroke identification system 102. In addition to the foregoing, one or more embodiments can also be described in terms of flowcharts comprising acts for accomplishing a particular result, as shown in FIG. 8. FIG. 8 may be performed with more or fewer acts. Further, the acts may be performed in differing orders. Additionally, the acts described herein may be repeated or performed in parallel with one another or parallel with different instances of the same or similar acts.

As mentioned, FIG. 8 illustrates a flowchart of a series of acts 800 for generating a digital vector image based on a digital raster image in accordance with one or more embodiments. While FIG. 8 illustrates acts according to one embodiment, alternative embodiments may omit, add to, reorder, and/or modify any of the acts shown in FIG. 8. The acts of FIG. 8 can be performed as part of a method. Alternatively, a non-transitory computer-readable medium can comprise instructions that, when executed by one or more processors, cause a computing device to perform the acts of FIG. 8. In some embodiments, a system can perform the acts of FIG. 8.

As shown in FIG. 8, the series of acts 800 includes an act 802 for receiving a digital raster image portraying a digital object. Additionally, the series of acts 800 includes an act 804 for generating, utilizing a stroke identification machine learning model, a stroke segmentation map. Further, in some embodiments, the act 804 includes an act 804a of generating, utilizing a mix transformer encoder, a latent stroke feature representation. Additionally, in one or more embodiments, the act 804 includes an act 804b of generating, utilizing a multi-scale attention network, a stroke segmentation map from the latent stroke feature representation. Further, as shown in FIG. 8, the act 804 can include an act 804c of wherein parameters of the stroke identification machine learning model are optimized utilizing a dice loss. As also shown in FIG. 8, in one or more embodiments, the series of acts 800 includes an act 806 of generating, utilizing the stroke segmentation map, a digital vector image comprising an editable, single-lined digital stroke.

In one or more embodiments, the series of acts 800 includes receiving a digital raster image portraying a digital object comprising a boundary region of boundary pixels and a fill region of fill pixels. Further, in some embodiments, the series of acts 800 includes generating, utilizing a stroke identification machine learning model, a stroke segmentation map indicating the boundary pixels. Additionally, in one or more embodiments, the series of acts 800 includes generating, utilizing the stroke segmentation map, a digital vector image comprising an editable, single-lined digital stroke for the boundary region of the digital object of the digital raster image.

In some embodiments, the series of acts 800 also includes generating, utilizing a mix transformer encoder of the stroke identification machine learning model, a latent stroke feature representation from the digital raster image. Additionally, in one or more embodiments, the series of acts 800 includes generating, utilizing a multi-scale attention network of the stroke identification machine learning model, the stroke segmentation map from the latent stroke feature representation. Further, in some embodiments, the series of acts 800 includes wherein parameters of the stroke identification machine learning model are optimized utilizing a dice loss and at least one of stroke contrast-filtered training samples or synthetic parallel shape training samples.

Additionally, in one or more embodiments, the series of acts 800 includes applying a self-attention mechanism to extract spatial relationship data and contextual image data from the digital raster image. Further, in some embodiments, the series of acts 800 includes passing the spatial relationship data and the contextual image data through attention mechanisms to refine the stroke segmentation map. Also, in one or more embodiments, the series of acts 800 includes wherein generating the stroke segmentation map from the latent stroke feature representation further comprises utilizing a decoder to up-sample the latent stroke feature representation to match an original resolution of the digital raster image.

Further, in some embodiments, the series of acts 800 includes wherein the stroke segmentation map comprises a single-channel segmentation map comprising pixel values for each pixel in the digital raster image indicating probabilities of belonging to a stroke foreground class or a stroke background class. Additionally, in one or more embodiments, the series of acts 800 includes wherein parameters of the stroke identification machine learning model are optimized utilizing a dice loss. In some embodiments, the series of acts 800 also includes wherein generating the editable, single-lined digital stroke for the boundary region of the digital object comprises generating a path segment, vertices of the path segment, and directional handles at ends of the vertices of the path segment.

Also, in one or more embodiments, the series of acts 800 includes generating a training dataset of raster images for modifying parameters of the stroke identification machine learning model by filtering the training dataset of raster images based on stroke contrast, and utilizing a synthetic data generation pipeline to introduce variation in image features for the training dataset of raster images.

Embodiments of the present disclosure may comprise or utilize a special purpose or general-purpose computer including computer hardware, such as, for example, one or more processors and system memory, as discussed in greater detail below. Embodiments within the scope of the present disclosure also include physical and other computer-readable media for carrying or storing computer-executable instructions and/or data structures. In particular, one or more of the processes described herein may be implemented at least in part as instructions embodied in a non-transitory computer-readable medium and executable by one or more computing devices (e.g., any of the media content access devices described herein). In general, a processor (e.g., a microprocessor) receives instructions, from a non-transitory computer-readable medium, (e.g., a memory), and executes those instructions, thereby performing one or more processes, including one or more of the processes described herein.

Computer-readable media can be any available media that can be accessed by a general purpose or special purpose computer system. Computer-readable media that store computer-executable instructions are non-transitory computer-readable storage media (devices). Computer-readable media that carry computer-executable instructions are transmission media. Thus, by way of example, and not limitation, embodiments of the disclosure can comprise at least two distinctly different kinds of computer-readable media: non-transitory computer-readable storage media (devices) and transmission media.

Non-transitory computer-readable storage media (devices) includes RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other medium which can be used to store desired program code means in the form of computer-executable instructions or data structures and which can be accessed by a general purpose or special purpose computer.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links which can be used to carry desired program code means in the form of computer-executable instructions or data structures and which can be accessed by a general purpose or special purpose computer. Combinations of the above should also be included within the scope of computer-readable media.

Further, upon reaching various computer system components, program code means in the form of computer-executable instructions or data structures can be transferred automatically from transmission media to non-transitory computer-readable storage media (devices) (or vice versa). For example, computer-executable instructions or data structures received over a network or data link can be buffered in RAM within a network interface module (e.g., a “NIC”), and then eventually transferred to computer system RAM and/or to less volatile computer storage media (devices) at a computer system. Thus, it should be understood that non-transitory computer-readable storage media (devices) can be included in computer system components that also (or even primarily) utilize transmission media.

Computer-executable instructions comprise, for example, instructions and data which, when executed by a processor, cause a general-purpose computer, special purpose computer, or special purpose processing device to perform a certain function or group of functions. In some embodiments, computer-executable instructions are executed on a general-purpose computer to turn the general-purpose computer into a special purpose computer implementing elements of the disclosure. The computer executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the disclosure may be practiced in network computing environments with many types of computer system configurations, including, personal computers, desktop computers, laptop computers, message processors, hand-held devices, multiprocessor systems, microprocessor-based or programmable consumer electronics, network PCs, minicomputers, mainframe computers, mobile telephones, PDAs, tablets, pagers, routers, switches, and the like. The disclosure may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

Embodiments of the present disclosure can also be implemented in cloud computing environments. In this description, “cloud computing” is defined as a model for enabling on-demand network access to a shared pool of configurable computing resources. For example, cloud computing can be employed in the marketplace to offer ubiquitous and convenient on-demand access to the shared pool of configurable computing resources. The shared pool of configurable computing resources can be rapidly provisioned via virtualization and released with low management effort or service provider interaction, and then scaled accordingly.

A cloud-computing model can be composed of various characteristics such as, for example, on-demand self-service, broad network access, resource pooling, rapid elasticity, measured service, and so forth. A cloud-computing model can also expose various service models, such as, for example, Software as a Service (“SaaS”), Platform as a Service (“PaaS”), and Infrastructure as a Service (“IaaS”). A cloud-computing model can also be deployed using different deployment models such as private cloud, community cloud, public cloud, hybrid cloud, and so forth. In this description and in the claims, a “cloud-computing environment” is an environment in which cloud computing is employed.

FIG. 9 illustrates a block diagram of an example computing device 900 that may be configured to perform one or more of the processes described above. One will appreciate that one or more computing devices, such as the computing device 900 may represent the computing devices described above (e.g., the server device(s) 104 and/or the client device 108). In one or more embodiments, the computing device 900 may be a mobile device (e.g., a mobile telephone, a smartphone, a PDA, a tablet, a laptop, a camera, a tracker, a watch, a wearable device). In some embodiments, the computing device 900 may be a non-mobile device (e.g., a desktop computer or another type of client device). Further, the computing device 900 may be a server device that includes cloud-based processing and storage capabilities.

As shown in FIG. 9, the computing device 900 can include one or more processor(s) 902, memory 904, a storage device 906, input/output interfaces 908 (or “I/O interfaces 908”), and a communication interface 910, which may be communicatively coupled by way of a communication infrastructure (e.g., bus 912). While the computing device 900 is shown in FIG. 9, the components illustrated in FIG. 9 are not intended to be limiting. Additional or alternative components may be used in other embodiments. Furthermore, in certain embodiments, the computing device 900 includes fewer components than those shown in FIG. 9. Components of the computing device 900 shown in FIG. 9 will now be described in additional detail.

In particular embodiments, the processor(s) 902 includes hardware for executing instructions, such as those making up a computer program. As an example, and not by way of limitation, to execute instructions, the processor(s) 902 may retrieve (or fetch) the instructions from an internal register, an internal cache, memory 904, or a storage device 906 and decode and execute them.

The computing device 900 includes memory 904, which is coupled to the processor(s) 902. The memory 904 may be used for storing data, metadata, and programs for execution by the processor(s). The memory 904 may include one or more of volatile and non-volatile memories, such as Random-Access Memory (“RAM”), Read-Only Memory (“ROM”), a solid-state disk (“SSD”), Flash, Phase Change Memory (“PCM”), or other types of data storage. The memory 904 may be internal or distributed memory.

The computing device 900 includes a storage device 906 including storage for storing data or instructions. As an example, and not by way of limitation, the storage device 906 can include a non-transitory storage medium described above. The storage device 906 may include a hard disk drive (HDD), flash memory, a Universal Serial Bus (USB) drive or a combination these or other storage devices.

As shown, the computing device 900 includes one or more I/O interfaces 908, which are provided to allow a user to provide input to (such as user strokes), receive output from, and otherwise transfer data to and from the computing device 900. These I/O interfaces 908 may include a mouse, keypad or a keyboard, a touch screen, camera, optical scanner, network interface, modem, other known I/O devices or a combination of such I/O interfaces 908. The touch screen may be activated with a stylus or a finger.

The I/O interfaces 908 may include one or more devices for presenting output to a user, including, but not limited to, a graphics engine, a display (e.g., a display screen), one or more output drivers (e.g., display drivers), one or more audio speakers, and one or more audio drivers. In certain embodiments, I/O interfaces 908 are configured to provide graphical data to a display for presentation to a user. The graphical data may be representative of one or more graphical user interfaces and/or any other graphical content as may serve a particular implementation.

The computing device 900 can further include a communication interface 910. The communication interface 910 can include hardware, software, or both. The communication interface 910 provides one or more interfaces for communication (such as, for example, packet-based communication) between the computing device and one or more other computing devices or one or more networks. As an example, and not by way of limitation, communication interface 910 may include a network interface controller (NIC) or network adapter for communicating with an Ethernet or other wire-based network or a wireless NIC (WNIC) or wireless adapter for communicating with a wireless network, such as a WI-FI. The computing device 900 can further include a bus 912. The bus 912 can include hardware, software, or both that connects components of computing device 900 to each other.

In the foregoing specification, the invention has been described with reference to specific example embodiments thereof. Various embodiments and aspects of the invention(s) are described with reference to details discussed herein, and the accompanying drawings illustrate the various embodiments. The description above and drawings are illustrative of the invention and are not to be construed as limiting the invention. Numerous specific details are described to provide a thorough understanding of various embodiments of the present invention.

The present invention may be embodied in other specific forms without departing from its spirit or essential characteristics. The described embodiments are to be considered in all respects only as illustrative and not restrictive. For example, the methods described herein may be performed with less or more steps/acts or the steps/acts may be performed in differing orders. Additionally, the steps/acts described herein may be repeated or performed in parallel to one another or in parallel to different instances of the same or similar steps/acts. The scope of the invention is, therefore, indicated by the appended claims rather than by the foregoing description. All changes that come within the meaning and range of equivalency of the claims are to be embraced within their scope.

What is claimed is:

1. A computer-implemented method comprising:
receiving a digital raster image portraying a digital object comprising a boundary region of boundary pixels and a fill region of fill pixels;
generating, utilizing a stroke identification machine learning model, a stroke segmentation map indicating the boundary pixels; and
generating, utilizing the stroke segmentation map, a digital vector image comprising an editable, single-lined digital stroke for the boundary region of the digital object of the digital raster image.

2. The computer-implemented method of claim 1, wherein generating the stroke segmentation map further comprises:
generating, utilizing a mix transformer encoder of the stroke identification machine learning model, a latent stroke feature representation from the digital raster image; and
generating, utilizing a multi-scale attention network of the stroke identification machine learning model, the stroke segmentation map from the latent stroke feature representation.

3. The computer-implemented method of claim 2, further wherein generating the stroke segmentation map from the latent stroke feature representation further comprises:
applying a self-attention mechanism to extract spatial relationship data and contextual image data from the digital raster image; and
passing the spatial relationship data and the contextual image data through attention mechanisms to refine the stroke segmentation map.

4. The computer-implemented method of claim 3, wherein generating the stroke segmentation map from the latent stroke feature representation further comprises utilizing a decoder to up-sample the latent stroke feature representation to match an original resolution of the digital raster image.

5. The computer-implemented method of claim 1, wherein the stroke segmentation map comprises a single-channel segmentation map comprising pixel values for each pixel in the digital raster image indicating probabilities of belonging to a stroke foreground class or a stroke background class.

6. The computer-implemented method of claim 1, wherein parameters of the stroke identification machine learning model are optimized utilizing a dice loss.

7. The computer-implemented method of claim 1, wherein generating the editable, single-lined digital stroke for the boundary region of the digital object comprises generating a path segment, vertices of the path segment, and directional handles at ends of the vertices of the path segment.

8. The computer-implemented method of claim 1, further comprising generating a training dataset of raster images for modifying parameters of the stroke identification machine learning model by:
filtering the training dataset of raster images based on stroke contrast; and
utilizing a synthetic data generation pipeline to introduce variation in image features for the training dataset of raster images.

9. A system comprising:
one or more memory devices; and
one or more processors configured to cause the system to:
generate, utilizing a mix transformer encoder of a stroke identification machine learning model, a latent stroke feature representation from a digital raster image;
generate, utilizing a multi-scale attention network of the stroke identification machine learning model, a stroke segmentation map from the latent stroke feature representation; and
convert the stroke segmentation map to a digital vector image comprising an editable, single-lined digital stroke for a boundary region of a digital object of the digital raster image.

10. The system of claim 9, wherein the one or more processors are configured to cause the system to generate the stroke segmentation map by applying a self-attention mechanism to extract spatial relationship data and contextual image data from the digital raster image.

11. The system of claim 10, wherein the one or more processors are configured to cause the system to generate the stroke segmentation map by passing the spatial relationship data and the contextual image data through attention mechanisms to refine the stroke segmentation map.

12. The system of claim 10, wherein the one or more processors are configured to cause the system to generate the stroke segmentation map from the latent stroke feature representation by utilizing a decoder of the multi-scale attention network to up-sample the latent stroke feature representation to match an original resolution of the digital raster image.

13. The system of claim 9, wherein the one or more processors are configured to cause the system to generate the stroke segmentation map by determining pixel values for each pixel in the digital raster image indicating probabilities of belonging to a stroke foreground class.

14. The system of claim 9, wherein the one or more processors are configured to cause the system to generate the editable, single-lined digital stroke for the boundary region of the digital object by generating a path segment and vertices of the path segment.

15. The system of claim 9, wherein parameters of the stroke identification machine learning model are optimized utilizing a dice loss and the one or more processors are configured to cause the system to generate a training dataset of raster images for modifying parameters of the stroke identification machine learning model by filtering the training dataset of raster images based on stroke contrast.

16. A non-transitory computer-readable medium storing executable instructions which, when executed by a processing device, cause the processing device to perform operations comprising:
generating, utilizing a stroke identification machine learning model, a stroke segmentation map from a digital raster image, wherein parameters of the stroke identification machine learning model are optimized utilizing a dice loss and at least one of stroke contrast-filtered training samples or synthetic parallel shape training samples;
generating, utilizing the stroke segmentation map, a digital vector image comprising a single-lined digital stroke for a boundary region of a digital object of the digital raster image; and
based on user interaction with the single-lined digital stroke, generating a modified digital vector image by modifying the single-lined digital stroke.

17. The non-transitory computer-readable medium of claim 16, wherein generating the stroke segmentation map further comprises generating, utilizing a mix transformer encoder of the stroke identification machine learning model, a latent stroke feature representation from the digital raster image.

18. The non-transitory computer-readable medium of claim 17, wherein generating the stroke segmentation map further comprises generating, utilizing a multi-scale attention network of the stroke identification machine learning model, the stroke segmentation map from the latent stroke feature representation.

19. The non-transitory computer-readable medium of claim 17, further wherein generating the stroke segmentation map from the latent stroke feature representation further comprises:
applying a self-attention mechanism to extract spatial relationship data and contextual image data from the digital raster image; and
passing the spatial relationship data and the contextual image data through attention mechanisms to refine the stroke segmentation map.

20. The non-transitory computer-readable medium of claim 18, wherein generating the stroke segmentation map from the latent stroke feature representation further comprises utilizing a decoder to up-sample the latent stroke feature representation to match an original resolution of the digital raster image, wherein the stroke segmentation map comprises a single-channel segmentation map comprising pixel values for each pixel in the digital raster image indicating probabilities of belonging to a stroke foreground class.
